(19) United States
(12) Patent Application Publication
(10) Pub. No.: US 2021/0175059 A1
(43) Pub. Date: Jun. 10, 2021

(54) ACQUISITION STRATEGY FOR OBTAINING ELECTRON-IONIZATION-LIKE SPECTRA

(71) Applicant: DH Technologies Development Pte. Ltd., Singapore (SG)

(72) Inventor: John Lawrence Campbell, Milton (CA)

(21) Appl. No.: 17/097,863

(22) Filed: Nov. 13, 2020

Related U.S. Application Data
(60) Provisional application No. 62/934,839, filed on Nov. 13, 2019.

(51) Int. Cl. H01J 49/00; H01J 49/02; H01J 49/42

(52) U.S. Cl. CPC H01J 49/0031; H01J 49/0045; H01J 49/022; H01J 49/4215; H01J 49/025

(57) ABSTRACT

In one aspect, a method of performing mass spectrometry is disclosed, which comprises forming at least two adduct ions of a molecular species in a sample, wherein said adduct ions comprise at least two different isotopes (e.g., the naturally occurring isotopes) of any of sodium and potassium, subjecting the adduct ions to Electron Impact Excitation of Ions from Organics (EIEIO) fragmentation to generate a plurality of fragment product ions, and using a mass analyzer to generate a mass spectrum of said product ions. The mass spectrum of the product ions can be analyzed to identify the parent ion. By way of example, the analysis of the mass spectrum can involve utilizing a reference library that contains mass spectral information regarding electron induced ionization of a plurality of reference compounds.

### RELATED US APPLICATIONS

This application claims the benefit of priority from U.S. Provisional Application Ser. No. 62/934,839, filed on Nov. 13, 2019, the entire contents of which is hereby incorporated by reference herein.

### FIELD

The present disclosure relates generally to methods and systems for performing mass spectrometry, and more particularly, to such methods and systems that employ Electron Impact Excitation of Ions from Organics (EIEIO) for the fragmentation of parent ions into a plurality of product ions.

### BACKGROUND

Mass spectrometry (MS) is an analytical technique for determining the elemental composition of test substances with both qualitative and quantitative applications. MS can be useful for identifying unknown compounds, determining the isotopic composition of elements in a molecule, determining the structure of a particular compound by observing its fragmentation, and quantifying the amount of a particular compound in a sample.

In some MS detection techniques, adduct ions are employed. Adduct molecules can be formed by combining two or more distinct molecules to form a single compound molecule that includes all of the atoms of the component molecules. The adduct molecule can be ionized to form an adduct ion. Some adduct ions can facilitate the fragmentation of one or more components of the adduct ion in a mass spectrometer. For example, some potassium adducted molecules can be fragmented to produce electron ionization (EI)-like fragments when these adducts are subjected to EIEIO fragmentation. This has generated much interest in the addition of potassium salts to samples under investigation to promote the formation of potassiated molecules that can be fragmented via EIEIO.

However, the addition of such salts can adversely impact the complexity of the overall mass spectral landscape. For example, a variety of salt clusters can be formed when ionizing such samples using electrospray ionization process.

### SUMMARY

In one aspect, a method of performing mass spectrometry is disclosed, which comprises forming at least two adduct ions of a molecular species in a sample, wherein said adduct ions comprise at least two different isotopes (e.g., the naturally occurring isotopes) of any of sodium and potassium, subjecting the adduct ions to Electron Impact Excitation of Ions from Organics (EIEIO) fragmentation to generate a plurality of fragment product ions, and using a mass analyzer to generate a mass spectrum of said product ions. The mass spectrum of the product ions can be analyzed to identify the parent ion. By way of example, the analysis of the mass spectrum can involve utilizing a reference library that contains mass spectral information regarding electron induced ionization of a plurality of reference compounds.

In some embodiments, the potassium isotopes comprise ³⁹K and ⁴¹K, and the sodium isotopes comprise ²⁴Na and ²³Na.

In some embodiments, the two isotopically different adduct ions containing potassium or sodium can be formed by adding any of a potassium or a sodium salt comprising at least two isotopic forms of sodium or potassium to a sample suspected of containing a molecular species of interest so as to generate an adduct molecular species. The adduct molecular species can then be ionized so as to form adduct ions.

In some embodiments, a mass spectrum of the sample is generated subsequent to reacting the sample with different isotopic salts of potassium or sodium in absence of fragmentation. Doublet mass peaks corresponding to the two isotopically different forms of the adduct ions are identified in the mass spectrum. A feedback system can receive the mass data of the doublet and adjust a mass filter to select the adduct ions for EIEIO fragmentation.

In some embodiments, a voltage applied between an orifice plate of a mass spectrometer and an ion guide disposed behind the orifice plate can be adjusted to discriminate the adduct ions from other ions present in the sample. In some such embodiments, a feedback system can be in communication with a voltage source applying a voltage differential between the orifice plate and the ion guide to adjust the applied voltage, based on the masses of the adduct ions deduced from the mass spectrum in absence of fragmentation, so as to select the adduct ions for transmission to the downstream components of the mass spectrometer for fragmentation and analysis.

In a related aspect, a mass spectrometer is disclosed, which comprises a reaction chamber for receiving a sample suspected of containing a molecular species of interest and any of potassium and sodium salt comprising at least two isotopic forms of sodium or potassium for forming a molecular adduct containing said molecular species and at least two isotopic forms of said potassium or sodium. An ionization source is in communication with the reaction chamber for receiving and ionizing the molecular adduct to generate at least two adduct ions of the molecular species with said at least two isotopic forms of potassium and sodium. The mass spectrometer can further include an orifice plate comprising an orifice for receiving ions, and at least one fragmentation chamber disposed downstream of the orifice plate for receiving the adduct ions and configured to cause fragmentation thereof via Electron Impact Excitation of Ions from Organics (EIEIO) so as to generate a plurality of product ions. A mass analyzer is disposed downstream of said fragmentation chamber, and an ion detector is disposed downstream of the mass analyzer for detecting ions passing through the mass analyzer and generating ion detection signals. A variety of different types of mass analyzers can be employed. In some embodiments, the mass analyzer can be a quadrupole mass analyzer. In other embodiments, the mass analyzer can be a time-of-flight (ToF) mass analyzer. Further, in some embodiments, a combination of quadrupole and time-of-flight mass analyzers can be employed.

An analysis module can receive the ion detection signals and generate a mass spectrum. The analysis module can be configured to analyze a mass spectrum of the adduct ions in absence of fragmentation to identify a mass doublet corresponding to the at least two isotopic forms of the adduct ions.

A feedback system can receive the mass information regarding the isotopic mass doublet (i.e., their mass-to-charge ratios) from the analysis module and can apply a control signal to a mass filter disposed upstream of the fragmentation chamber for selecting the adduct ions for passage to the downstream mass analyzer. By way of example, the mass filter can be implemented as a quadrupole mass filter having four rods arranged in a quadrupole configuration and having a space therebetween to allow the passage of ions therethrough.

The mass spectrometer can include at least one RF source configured for application of RF voltage(s) to the quadrupole rods of mass filter and the mass analyzer, when these components are implemented using a set of multipole rods (e.g., quadrupole rods).

Further understanding of various aspects of the present teachings can be obtained by reference to the following detailed description in conjunction with the associated drawings, which are described briefly below.

### BRIEF DESCRIPTION OF THE DRAWINGS

FIG. 1 is a flow chart depicting various steps in a method according to an embodiment for performing mass spectroscopy,

FIG. 2 is a schematic diagram of a mass spectrometer according to an embodiment of the present teachings, and

FIG. 3 is a partial schematic view of a mass spectrometer in accordance with an embodiment in which a voltage source can apply an adjustable voltage differential between an orifice plate and a downstream ion guide for discriminating the potassiated or sodiated adduct ions from others.

### DETAILED DESCRIPTION

The present disclosure relates generally to methods and systems for analyzing a sample using mass spectrometry in which potassium or sodium adducted molecules (generated, for example, by reacting the molecules with potassium or sodium salt) are formed and subjected to fragmentation via Electron Impact Excitation of Ions from Organics (EIEIO). It has been discovered that the problem of the added complexity of the mass spectra that can result due to the presence of various salt clusters can be addressed by using a mixture of multiple (typically two) isotopes of sodium and potassium (e.g., ³⁹K and ⁴¹K, and ²⁴Na and ²³Na), rather than using only the most naturally abundant isotopes of sodium and potassium, to obtain a distinct pattern of mass lines in a mass spectrum of the adduct ions in absence of fragmentation. The distinct pattern can then be utilized to select the adduct ions for fragmentation, as discussed in more detail below. As such, the methods and systems of the present disclosure can allow utilizing the EIEIO fragmentation of potassiated and sodiated adduct ions while ensuring that the resultant mass spectra can be readily analyzed. In particular, the EIEIO fragmentation of such adduct ions can resemble the electron-induced fragmentation of molecular species adducted to potassium or sodium. This allows using reference libraries (such as NIST library) for the identification of the molecular species adducted to potassium or sodium.

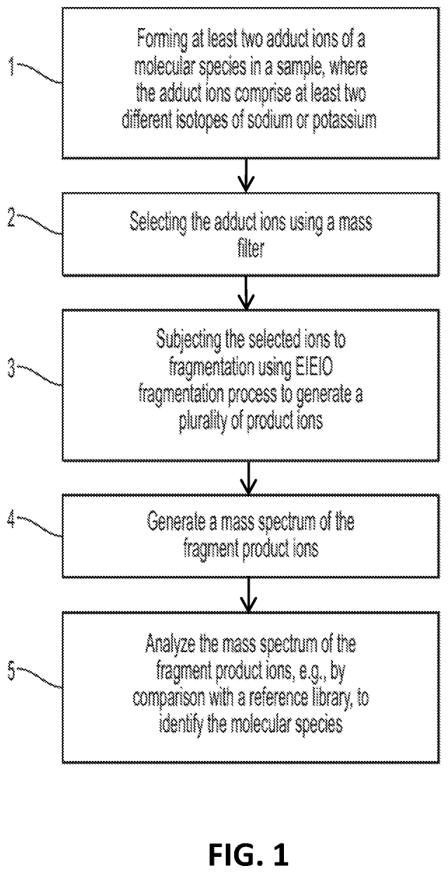

With reference to the flow chart of FIG. 1, in an embodiment of a method according to the present teachings, at least two adduct ions of a molecular species (herein also referred to as a parent ion) in a sample are formed, where the adduct ions comprise at least two different isotopes of sodium or two different isotopes of potassium. For example, in some embodiments, a parent molecule (herein also referred to as a molecular species) of interest can be reacted with salts of ³⁹K and ⁴¹K to form adduct molecules comprising the parent molecule and ³⁹K and ⁴¹K. Alternatively or in addition, a molecular species of interest can be reacted with salts of ²⁴Na and ²³Na to form adduct molecules comprising the molecular species and ²⁴Na and ²³Na. A variety of salts of potassium and sodium can be employed. Some examples of such salts include, without limitation, halide salts of potassium or sodium (KCl and NaCl, KBr and NaBr), organic acid salts of potassium and sodium (KOAc and NaOAc, where OAc=acetate). An example of a chemical reaction between a molecular species (M) with KCl to form an adduct molecule comprising the molecular species and potassium (K) is given below:

M+K⁺→[M+K]⁺

The adduct molecules can be ionized to form two adduct ions in the sample under study, where the two adduct ions comprise different isotopes of potassium or sodium. For example, in one embodiment, the two adduct ions can be in the form of [M+³⁹K]+ and [M+⁴¹K]⁺, where M denotes a molecular species of interest. In another embodiment, the two adduct ions can be in the form of [M+²⁴Na]⁺ and [M+²³Na]⁺.

In some embodiments, the adduct ions can be selected (step 2), e.g., by using a filter (such as a quadrupole filter) and subjected to fragmentation using Electron Impact Excitation of Ions from Organics (EIEIO) fragmentation (step 3) process to generate a plurality of product ions.

In some such embodiments, the selection of the adduct ions via a filter can be achieved in the following manner. Specifically, a mass spectrum of the sample containing the adduct ions can be obtained in absence of fragmentation. The mass difference between the two adduct ions corresponding to the two different isotopes of potassium or sodium can result in the presence of a doublet in the mass spectrum. The doublet can be identified and the masses of the lines in the doublet can be used to configure a filter (e.g., a quadrupole filter) to select the adduct ions for fragmentation.

As the different isotopes of potassium and sodium differ only in their nuclear properties and not their electronic properties, it is expected that the adduct ions of the different isotopes behave similarly when subjected to EIEIO fragmentation.

The following two reactions have been hypothesized for the fragmentation of an adduct ion of a molecular species (M). In the reaction below, it is assumed that the molecular species is adducted with potassium (K), but similar reaction mechanisms are expected for sodium:

[M+K]⁺+electrons→M⁺*+K*, M⁺*→[Fragments]⁺

[M+K]⁺+electrons→[M+K]⁺*→[Fragments+K]⁺

In many embodiments, only the first fragmentation reaction is of considerable interest as it is the one in which the pattern of fragment products resembles the spectra associated with electron-induced (EI) fragmentation of neutrals for which reference libraries (such as NIST library) are available.

In some embodiments, a mass spectrum of the fragment ion products can be generated (step 4), e.g., using one or more mass analyzers and the mass spectrum can be analyzed, e.g., via comparison with a reference library as noted above to identify the molecular species of interest (step 5), if any, in a sample under investigation. The second reaction becomes isotopically labeled (via retention of the isotopically enriched potassium adduct) while the first reaction does not. Therefore, if the precursor ions for an EIEIO fragmentation event were selected such that both the natural and isotopically enriched adducts of a molecule were co-isolated for EIEIO fragmentation (e.g., [M+³⁹K]+ and [M+⁴¹K]⁺), the fragment ions could be distinguished from one another if a 2 Da window is selected for fragmentation. In some cases, this can allow subtraction of the peaks that contain both the natural and isotopically-enriched potassium ions prior to comparison with a reference library (e.g., NIST), thereby improving data quality. An additional benefit is that the desired reaction channel is not isotopically diluted, thus not affecting the overall performance.

A method according to the present teachings for performing mass spectrometry can be implemented in a variety of mass spectrometers, such as, quadrupole, time-of-flight (TOF), combined quadrupole/TOF spectrometers, among others.

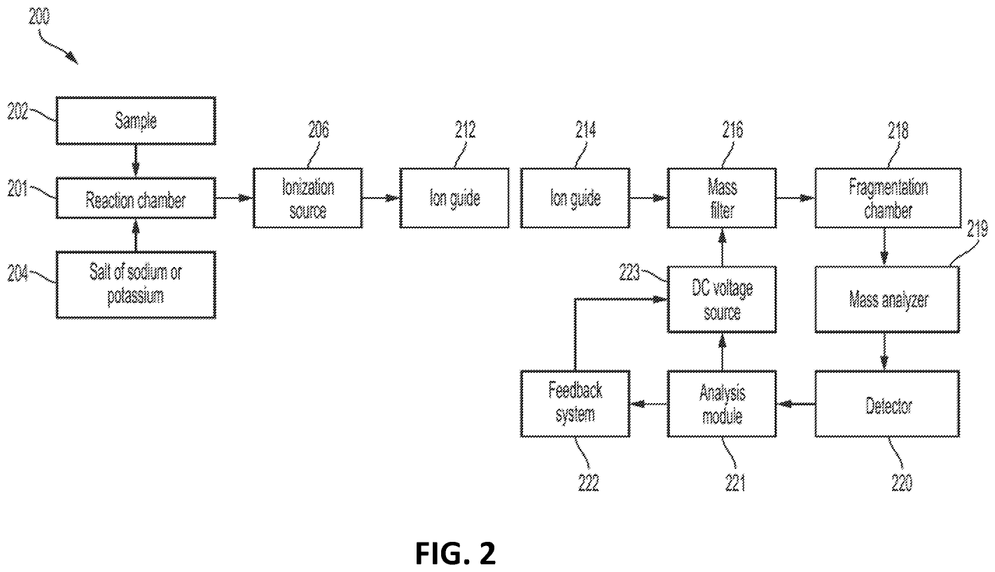

By way of example, FIG. 2 schematically depicts a mass spectrometer 200 according to an embodiment of the present teachings, which includes a reaction chamber 201 that can receive a sample suspected of containing a molecular species of interest (herein also referred to as a parent molecule) from a sample source 202 and sodium or potassium salts of two isotopic forms of sodium or potassium from an additive system 204. The molecular species can react with the two isotopic forms of sodium or potassium salt, e.g., in a manner discussed above, to generate adduct molecules, each of which comprises a different isotope of potassium or sodium.

An ionization source 206, such as an atmospheric ionization source, can receive the adduct molecules and ionize the adduct molecules to generate adduct ions, which comprise two different isotopic forms of sodium or potassium. For example, in some embodiments, the adduct ions can include two types of ions, one of which comprises ³⁹K and the other comprises ⁴¹K. In other embodiments, the adduct ions can include two types of ions, one of which comprises ²⁴Na and the other comprises ²³Na.

In this embodiment, a combination of a curtain chamber and an orifice plate (not shown in the figure) are provided through which the ions pass to enter an ion guide 212 (herein also referred to as Qjet region). The ion guide 212 can be implemented using four rods positioned in a chamber and arranged in a quadrupole configuration. Another ion guide 214 (herein referred to as Q1 region) is positioned downstream of the ion guide 212 and receives the ions from the ion guide 212. Similar to the ion guide 212, the ion guide 214 includes four rods disposed in a chamber in a quadrupole configuration. An ion lens (not shown in the figure, and referred to herein as IQ0 lens) is positioned between the Qjet and Q0 region.

In use, the Qjet rods can be employed to capture and focus the ions received through the orifice using a combination of gas dynamics and radio frequency fields. The ions pass through the Qjet region and are focused via the IQ0 lens into the downstream Q0 region. In some embodiments, the application of RF voltages to the Q0 rods confine the ions in proximity of the central axis and allow the ions to enter a downstream quadrupole mass analyzer 216 (herein also referred to as Q1 region), which can include four quadrupole rods positioned in a vacuum chamber that can be evacuated to a pressure, for example, less than about 1×10 ⁻⁴ Torr (e.g., about 5×10⁻⁵ Torr). In this embodiment, an ion lens (not shown in the figure but referred to herein as IQ1 lens) is positioned between the Q0 and Q1 regions.

As will be appreciated by a person skill in the art, the quadrupole rod set Q1 can be operated as a conventional transmission RF/DC quadrupole mass filter to select an ion of interest and/or a range of ions of interest. By way of example, the quadrupole rod set can be provided with RF/DC voltages suitable for operation in a mass resolving mode. As should be appreciated, taking the physical and electrical properties of Q1 into account, parameters for an applied RF and DC voltage can be selected so that Q1 establishes a transmission window of chosen m/z ratios, such that these ions can traverse Q1 largely unperturbed. Ions having m/z ratios falling outside the window, however, do not attain stable trajectories within the quadrupole and can be prevented from traversing the quadrupole rod set Q1. As discussed in more detail below, in this embodiment, the Q1 rod set can be used to select the adduct ions comprising two isotopic forms of potassium or sodium for fragmentation.

In this embodiment, a fragmentation chamber 218 is positioned downstream of the Q1 region to receive the adduct ions and cause their fragmentation. More specifically, in this embodiment, the adduct ions can be subjected to Electron Impact Excitation of Ions from Organics (EIEIO) for fragmentation of the parent ions to generate a plurality of product ions.

The product ions pass through a mass analyzer 218 and are detected by a downstream detector 220. By way of example, the mass analyzer 218 can be a quadrupole analyzer, which includes a plurality of quadrupole rods arranged so as to allow the passage of ions therebetween.

An analysis module 221 can receive the detection signals generated by the detector 220 and generate a mass spectrum of the product ions based on those detection signals.

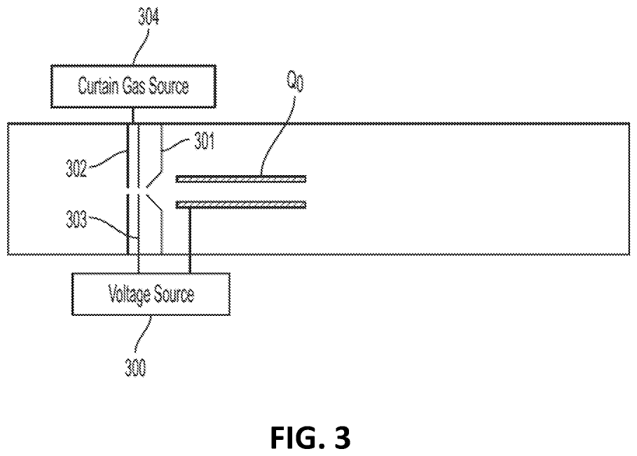

In use, a mass spectrum of a sample containing the adduct ions can be obtained without causing ion fragmentation. A mass doublet corresponding to the two isotopic forms of the adduct ions of potassium or sodium can be identified in the mass spectrum of the sample by the analysis module. The analysis module can provide the mass-to-charge ratios of the mass doublet to a feedback system 222, which is in communication with a voltage source 203 that can apply appropriate voltage(s) to the Q1 quadrupole for configuring the Q1 quadrupole for selecting the adduct ions corresponding to the mass doublet for fragmentation. As shown schematically in FIG. 3, in some embodiments, the feedback system 222 can be in communication with an adjustable dc voltage source 300 that is configured to apply a dc voltage differential between an orifice plate 301 and the Q0 rods. The adjustable voltage can be determined based on the mass-to-charge ratios of the mass lines of the doublet observed in the mass spectrum so as to discriminate the potassiated or sodiated adduct ions from the rest of ions as the ions pass through the orifice to the Q0 region. FIG. 3 further shows that the mass spectrometer can include a curtain plate 302 and an orifice plate 303 and a source of gas 304 for introducing a gas flow in the chamber formed between the curtain plate and the orifice plate (herein referred to as the curtain chamber).

As noted above, a mass spectrum of the product ions generated through fragmentation of the adduct ions can be obtained and analyzed, e.g., via comparison of the pattern of the mass lines in the spectrum with a reference library to determine whether the molecular species of interest is present in the sample under investigation.

Those having ordinary skill in the art will appreciate that various changes can be made to the above embodiments without departing from the scope of the invention.

What is claimed is:

1. A method of performing mass spectrometry, comprising:
forming at least two adduct ions of a molecular species in a sample, wherein said adduct ions comprise at least two different isotopes of any of sodium and potassium,
subjecting said adduct ions to Electron Impact Excitation of Ions from Organics (EIEIO) fragmentation to generate a plurality of fragment product ions, and
using a mass analyzer to generate a mass spectrum of said productions.

2. The method of claim 1, wherein said potassium isotopes comprise ³⁹K and ⁴¹K.

3. The method of claim 1, wherein said sodium isotopes comprise ²⁴Na and ²³Na.

4. The method of claim 1, wherein said step of forming at least two adduct ions comprises
adding any of potassium and sodium salt comprising at least two isotopic forms of sodium or potassium to a sample suspected of containing said molecular species so as to generate an adduct molecular species, and
ionizing said adduct molecular species to form said adduct ions.

5. The method of claim 1, further comprising analyzing said mass spectrum so as to identify said molecular species associated with said adduct ions.

6. The method of claim 5, wherein said step of analyzing said mass spectrum comprises utilizing a library of fragment ions of a plurality of reference molecular species generated via electron ionization so as to identify said molecular species associated with said adduct ions.

7. The method of claim 4, further comprising generating a mass spectrum of said sample subsequent to adding any of said potassium and sodium salt thereto and in absence of fragmentation.

8. The method of claim 7, further comprising identifying said at least two isotopic forms of said adduct ions in said mass spectrum of the sample.

9. The method of claim 8, further comprising, prior to said step of subjecting said adduct ions to the EIEIO fragmentation, utilizing a mass filter to mass select said at least two isotopic forms of said adduct ions based on masses of the doublet identified in said mass spectrum.

10. The method of claim 9, further comprising utilizing a voltage applied between an orifice plate of a mass spectrometer and a set of quadrupole rods disposed downstream of said orifice plate to discriminate said adduct ions from other ions present in said sample.

11. The method of claim 1, wherein said isotopes comprise naturally-occurring isotopes.

12. A mass spectrometer, comprising:
a reaction chamber for receiving a sample suspected of containing a molecular species and any of potassium and sodium salt comprising at least two isotopic forms of sodium or potassium for forming a molecular adduct containing said molecular species and at least two isotopic forms of said potassium or sodium,
an ionization source in communication with said reaction chamber for receiving and ionizing said molecular adduct to generate at least two adduct ions of said molecular species with said at least two isotopic forms of potassium and sodium,
an orifice plate comprising an orifice for receiving ions,
at least one fragmentation chamber disposed downstream of said orifice plate for receiving said adduct ions and configured to cause fragmentation thereof via Electron Impact Excitation of Ions from Organics (EIEIO) so as to generate a plurality of product ions,
a mass analyzer disposed downstream of said fragmentation chamber, and
an ion detector disposed downstream of said mass analyzer for detecting ions passing through said mass analyzer and generating ion detection signals

13. The mass spectrometer of claim 12, further comprising an analysis module for receiving said ion detection signals and generating a mass spectrum

14. The mass spectrometer of claim 12, wherein said analysis module is configured to analyze a mass spectrum of said adduct ions in absence of fragmentation to identify a mass doublet corresponding to the at least two isotopic forms of said adduct ions.

15. The mass spectrometer of claim 14, further comprising a mass filter disposed upstream of said fragmentation chamber.

16. The mass spectrometer of claim 15, further comprising a feedback system receiving information about said mass doublet and generating one or more feedback signals based on said information for application to said mass filter for selecting said adduct ions for passage to said downstream mass analyzer.

17. The mass spectrometer of claim 16, wherein said mass filter comprises a quadrupole mass filter having four rods arranged in a quadrupole configuration.

18. The mass spectrometer of claim 17, further comprising an RF source for application of RF voltage(s) to said quadrupole rods.

19. The mass spectrometer of claim 18, wherein said feedback system is in communication with said RF source to apply said feedback signals thereto so as to adjust one or more voltages applied to said quadrupole rods to allow selective passage of said adduct ions through the mass filter.
